(19) United States
(12) Patent Application Publication
(10) Pub. No.: US 2011/0134332 A1
(43) Pub. Date: Jun. 9, 2011

(54) Camera-Based Color Correction Of Display Devices

(76) Inventors: Christopher O. Jaynes, Denver, CO (US); Thomson Comer, Denver, CO (US); Stephen B. Webb, Denver, CO (US); Michael Tolliver, Denver, CO (US)

(21) Appl. No.: 12/956,572

(22) Filed: Nov. 30, 2010

Related U.S. Application Data
(60) Provisional application No. 61/264,988, filed on Nov. 30, 2009.

(51) Int. Cl. H04N 9/64; G09G 5/02

(52) U.S. Cl. 348/708; 345/590; 348/E09.025; 348/E09.037

(57) ABSTRACT

A method of generating a display from a plurality of color image display sources such as a projector or a video monitor. The non-linear color response is first determined for each projector/monitor by using a color camera or other sensor to capture a displayed image. Each of the display sources is then linearized using the inverse of the respective non-linear color response. A common reachable gamut is derived in an observed color space for each of the sources. A transform is determined that maps an observed gamut to a target device-specific color space for each of the display sources. The respective transform is then applied to color values input to each of the display sources to make more similar the observed color response of each of the displays.

### RELATED APPLICATIONS

This application claims the benefit of U.S. Provisional Application Ser. No. 61/264,988 filed Nov. 30, 2009, incorporated herein by reference.

### BACKGROUND

Displays that are generated by multiple display devices may result in undesirable visual artifacts if the underlying differences in each display are not taken into account and corrected as images are rendered to the display. For example, overlapping projectors or a tiled array of LCD panel display devices may be used to generate a single display composed of multiple display images. Non-uniformity of the color of images displayed in multi-display systems may be a problem when two or more display devices are used to generate a single display. In particular, color differences among the different display devices may produce visual artifacts.

### SOLUTION

The present system corrects color non-uniformities in multi-projector or multi-monitor displays by utilizing a method that employs a color camera to measure the color output of different display devices and then derives one or more mappings from the color space of each display into a common color space. In doing so, the observed color response of each of the displays is more similar and the differences in color appearance are reduced.

The embodiments described herein use a camera to measure these color differences and then derive a function that corrects the differences by intersecting the color output of each display map (through the derived function) into a target color space. The present system applies a correction method whereby a correction function can be encoded in a variety of ways depending on the underlying complexity of the correction function and the processing time available to compute the solution. In the case when the color spaces differ by a linear transform, it is possible to represent this function as a linear matrix, while more complex functions may require that the transform is approximated by a family of linear mappings that span the color space. When the underlying model is unknown or too complex for parametric description, the function can be encoded directly as a lookup table that encodes directly, the difference between each device-specific color space and the target space.

In the case when the transform is represented by a family, or single, linear function, these correction functions may be encoded and used efficiently in existing or yet-to-be-developed graphics hardware. Subsequent nonlinear aspects of a device's particular color response may then be corrected in a post-processing step.

### BRIEF DESCRIPTION OF THE DRAWINGS

FIG. 1A is a diagram showing an exemplary multi-display system using multiple video monitors;

FIG. 1B is a diagram showing an exemplary multi-display system using multiple projectors;

FIG. 2 is a high-level diagram showing exemplary components of the present system;

FIG. 3A is a diagram showing an exemplary high-level set of steps performed by the method used with the present system;

FIG. 3B is a diagram showing an exemplary set of steps performed in the measurement phase of the present system;

FIG. 3C is a diagram showing an exemplary set of steps performed in the computation phase of the present system;

FIG. 4 is a diagram showing the difference between the device-specific color response function and the target color values modeled as a linear distortion within a tri-stimulus space; and

FIG. 5 is an exemplary diagram showing the result of mapping multiple projectors/monitors gamut into a common observed space.

### DETAILED DESCRIPTION

In one embodiment, the present method operates with a multiple display system in which multiple display devices (e.g., LCD video monitors) or multiple projectors are used to display a single image. In another embodiment, color correction of multiple display devices is effected to provide a uniform color response across all of the devices even when they are not in proximity to one another, or when the devices are displaying different images. For example, a set of displays being used for medical diagnostics should all exhibit a similar color response even if all of them are not near one another.

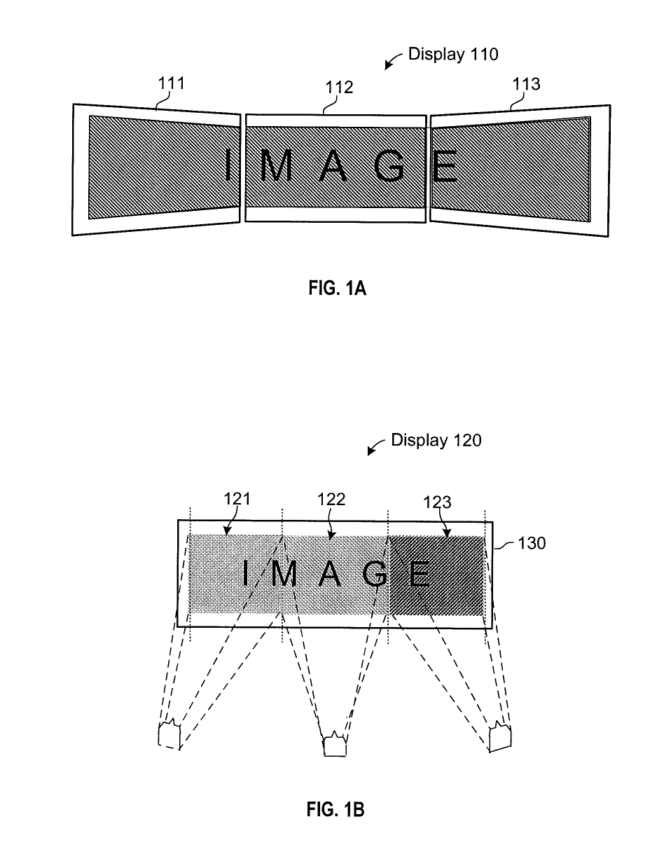

FIGS. 1A and 1B show two examples of multi-display systems that can benefit from color correction as provided by the present method. In one example, an image is rendered across three monitors. FIG. 1A shows three flat-panel video monitors 111, 112, 113, being used as a single display 110.

Another example of a multi-display system is a multi-projector display with overlapping frustums that have been blended into a seamless image projected on a screen. FIG. 1B shows a seamless multi-projector display 120 created by three projected overlapping (or adjacent) images 121, 122, 123, illuminating a screen 130.

In the present method, the color output of the display devices composing a multi-device display is observed and the color output of each display is automatically corrected. The method is fully automatic, and may utilize a widely-available digital color camera to capture the color output of the displays. When color values are passed through each display's color correction function, the resulting display colors are more similar in appearance. Although direct capture of color values in a sensor is known; previous methods differ significantly from the present method in that previous methods (1) capture the color values at one (or a few) locations with a radiometer, (2) assume linearity of the underlying function, and (3) map the color space to a target space that is known and independent of the behavior of other devices. The present approach is inherently focused on discovering a target color space based on the measurements of multiple devices, and then determining a target color space that is reachable by all devices and which has additional constraints (e.g., maximum contrast).

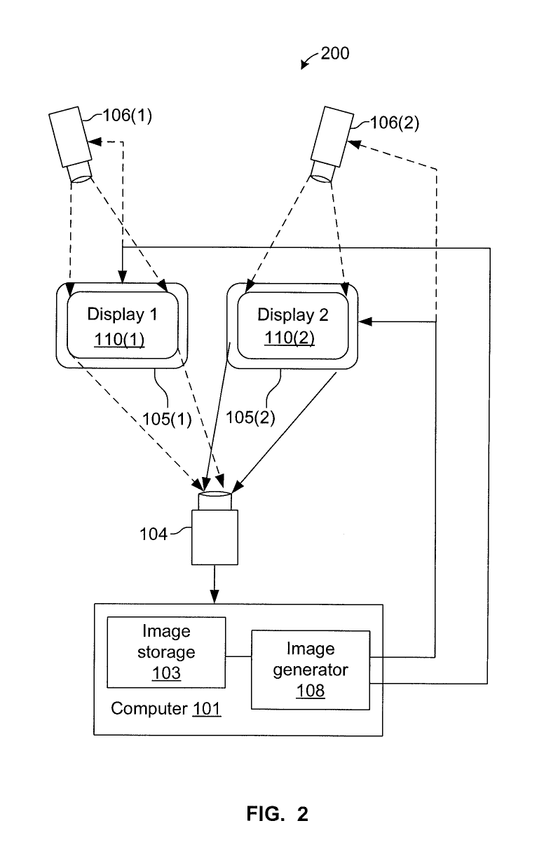

FIG. 2 is a high-level diagram showing exemplary components of the present system 200. As shown in FIG. 2, display devices (e.g., video monitors) 105(1) and 105(2), or alternatively, projectors 106(1)/106(2), are connected to one or more computers 101, each including an image generator 108 that generates a respective display 110(1)/110(2). Measurement camera 104 captures measurement images displayed from images stored in computer memory 103. Camera 104 measures the color response of each of the displays which is used to derive a color correction function for each of the displays. This function is then used by the image generator to modify the color values input to each display to ensure color similarity.

Alternative embodiments include (1) a separate device that applies the color correction function, (2) an external ‘warp/blend’ video processor that takes input video color, corrects for color differences and then outputs the corrected video signal, (3) projectors that have built-in color correction engines, and (4) a personal computer in which color correction occurs in software or in the video driver. The observed color response of a particular display depends on several different factors including physical characteristics of the display device (liquid crystal response, digital micro-mirror imperfections, bulb spectral distribution, etc.), internal signal processing, as well as environmental conditions. Consider the case where the displays are digital projectors. The color response depends factors such as on signal processing, light source wavelength, and properties of the internal mirrors, for example. These factors vary within projector models, across different models of projectors, and may change over time. Various configurations of light source, internal optical, and color mixing components may be the source of observed color differences.

In addition to these internal sources, the display surface itself may yield observed color differences based on differing reflectance properties. Rather than parametrically modeling each of these independent sources of error, the method described herein observes the differences between displays directly with a camera and derives a color correction function for each display. Regardless of the underlying source of error, this corrective function can directly map different color responses into a single device-specific color space.

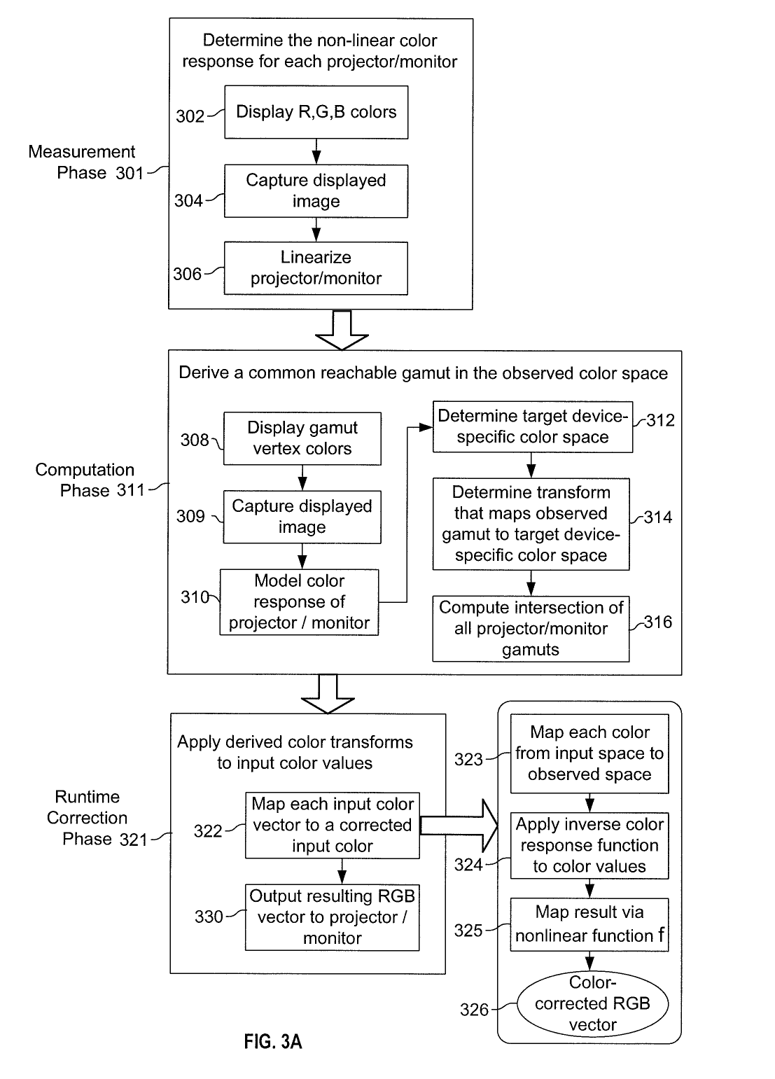

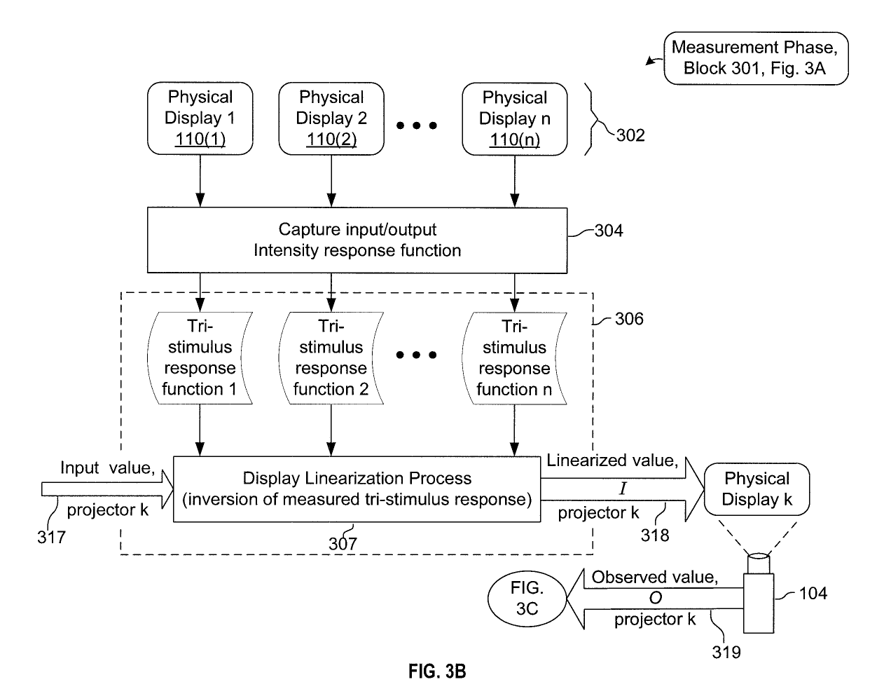

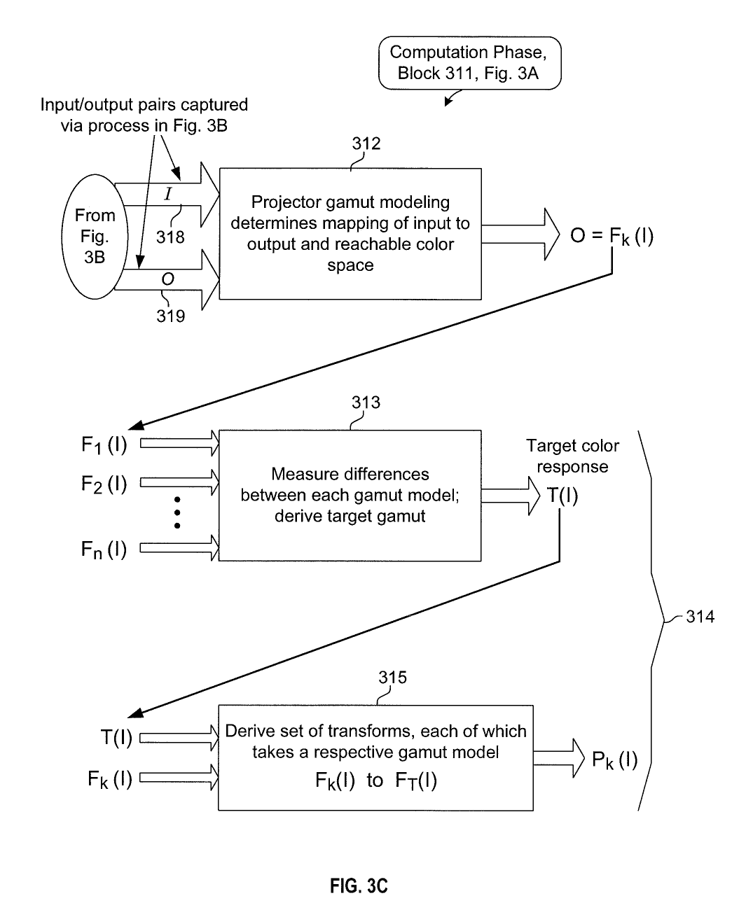

FIG. 3A is a diagram showing an exemplary high-level set of steps performed by the method used with the present system. As shown in FIG. 3A, the present method may be broadly divided into three phases: measurement phase 301, computation phase 311, and runtime correction phase 321.

In measurement phase 301, in an exemplary embodiment, a pattern containing Red, Green, and Blue colors in a predetermined arrangement is input to each projector 106/monitor 105, and the pattern is displayed on a screen 130 (or on a monitor 105) at step 302. A digital color camera captures the displayed images to observe the color response for multiple different projectors or monitors, at step 304. High-dynamic range sensing during this measurement phase may optionally be employed to achieve accurate measurements that span the response of the projector while using a sensor with a possibly lower-dynamic range. In this high-dynamic range process, known in the art (and often simply termed ‘HDR’), multiple shutter speeds are used to measure the same color value from the projector to reconstruct a virtual image of the projected color that represents a relatively high-dynamic range image.

At step 306, each projector 106/monitor 105 is linearized, as explained in detail with respect to FIG. 3B, below. When the projector/monitor is known to be in a particular mode with a known gamma, steps 302 and 304 are not necessary. When the projector/monitor is known to be linear, the linearization process including steps 302, 304, and 306 can be eliminated.

Given the measurements made in measurement phase 301, the computation phase 311 derives a correction function that maps each projector's/monitor's color response into a common space. Using these mappings, each projector/monitor generates color values in a ‘device-specific’ color space for the raw color space of each device that is to be measured. Information about the color response of camera 104 itself allows this measured device-specific space to be mapped into any color response space that is reachable by each of the projectors/monitors.

The present method uses a projector-observer (or monitor-observer) transformation, which is a warping of input [R G B] values to some other tri-stimulus color space. Although it is possible to directly measure each input-output pair, it is generally too cumbersome to measure each point explicitly unless opportunistic, online measurement (described in detail below) is used. A direct lookup table approach, as described herein, does not need to separate the nonlinear/linear functions because, at each point, all that is stored in the lookup table is the output color value that should be rendered given an input value. A lookup table value is determined for each point by starting with a table having a 1:1 correspondence between input and output values (i.e., with no input value warping), and changing the values of only the points that are opportunistically observed.

In the computation phase, the present correction functions are updated to take into account each opportunistic observation. For example, if the correction functions are lookup tables, the entry that encodes how each projector/monitor should map the color that was opportunistically observed is updated in a manner that drives each of the projectors/monitors towards a similar response in the camera. The updated correction functions are implemented without interruption of the normal operation of the projectors/monitors, and the process continues. This process can represent arbitrary functions including nonlinear ones.

Finally, the runtime correction phase 321 takes these mappings and then applies them to the incoming color values for each projector 106/monitor 105 to derive respective new input color values that will yield the correct output on a per-projector/-monitor basis. Each of these phases is described in detail below.

### Measurement Phase

Because the present method does not model the complex underlying source of color differences, only the color response of each projector or display device (e.g., video monitor) needs to be directly measured via a color camera 104. Resulting differences between projectors 106/monitors 105 in this color response space are modeled for processing and then re-mapped into the color response of each projector 106/monitor 105 at runtime. The distortion between projector/monitor input color and the observed space may be modeled in any tri-stimulus color space (e.g., RGB or CIE). Although for any given projector/monitor input value 317 there is a corresponding output value as measured in the color camera, a lengthy process would be required to explicitly measure each of these points to derive a direct mapping.

In the present embodiment, the distortion between the projector 106/monitor 105 input color and the observed space is modeled. FIG. 3B is a diagram showing a more detailed exemplary set of steps performed in the measurement phase 301 of the present system. The color response of a potentially non-linear projector 106 (or monitor 105) is measured using camera 104. This color response may be a non-linear function that can be modeled as a gamma function where the input color is raised to some power and then generated on the projector/monitor output. As a result, the output energy of the projector/monitor is nonlinearly related to the input color. As shown in FIG. 3B, this nonlinear color response function is determined by generating Red, Green, and Blue values at increasing values of input color, in step 302, and observing their output response via measurement camera 104, in step 304. Once this non-linear function is known, the projector/monitor response can be linearized.

In step 306, the non-linear tri-stimulus response function is measured for each projector 106/monitor 105. In measuring the non-linear functions, the Red/Blue/Green values may be driven independently, resulting in a three independent models of the projector response that describe the input/output relationship of each color channel. Alternatively, the projector response can be modeled as a single 3D function. In order to measure this function, the response of each channel at increasing values is measured while inputting a variety of values on the other two color channels.

For example, a nonlinear function that represents the relationship between input intensity values and the observed intensities may be represented by a sigmoid for each of the color values independently (in which case the input intensity, I, is a single input value for a particular color), or as a single three dimensional function (in which case I represents a length-3 vector of color values):

O=1/(1+êI)

where O is the observed output intensity and I is the input intensity value. Other nonlinear functions include a power function, also referred to as a gamma function in the context of displays that exhibit a response characterized by:

O=Îp

where p is the power value that typically ranges from 1.0 to 3.0 on modern displays. The nonlinear function can be captured and represented simply as a lookup table that maps input to output responses, or it can be explicitly modeled by capturing input/output pairs and then fitting a parametric function (such as the two shown above) to those pairs. Similarly, these functions can be captured and stored non-parametrically as lookup tables. In the present case, three independent lookup tables can be created, or a single three-dimensional table can be used when the color value responses may not be independent.

In either of the above cases, the projector color space can then be normalized by inverting the known nonlinear function that the display exhibits, at step 307, to generate a linearized value 318 for the input intensity I. This linearized value 318 (I) is input to a projector 106/monitor 105, where it is captured in camera 104 as an observed value 319 for the output intensity, O. For example, in the case of a power function, the display may be driven by first raising the input value to the power 1/p so that when the display renders that input value it is then in a linear space. Both I and O are used as inputs to the computation phase, described in detail below.

### Computation Phase

FIG. 3C is a diagram showing an exemplary set of steps performed in the computation phase 311 of the present system, the operation of which is best understood by viewing this diagram in conjunction with FIG. 3A. After the nonlinear function of the projector 106/monitor 105 is measured and linearized, the remaining differences between each of the device-specific responses and a target color space are modeled in the computation phase. The target color space can be derived based on a variety of methods; however, the target color space must be reachable by all projectors (i.e., all color values in this space must be displayable by each of the projectors).

Example target color spaces include the gamut that has the greatest volume and is reachable by all projectors, or a color space that has the added constraint that it is axis-aligned with the input space but is still the largest volume reachable by all projectors. This target space may also be derived from input from a user. For example, if an operator determines that the contrast of red colors should be enhanced, but high-contrast is not required with blue colors, then these constraints can be taken into account when computing the target color space. In all cases, the specific target space is derived from a set of observations (steps 308, 309, FIG. 3A) and a processing stage (steps 310, 312) that determines a target device-specific color space. A function, Fₖ (I), that models these differences is thus determined for each of the projectors/monitors, where O=Fₖ (I). The differences between each device-specific space and this target color space are then computed (at step 313) to yield a color response function T(I). These differences are represented in the corresponding values of input color I vs. target color O.

A tri-stimulus Red, Blue, Green input value is a vector within the color space defined by the three basis vectors [R 0 0], [0 G 0], [0 0 B], where color vectors are written as [R G B]. A projector/monitor gamut is defined as the volume of all reachable color values by that projector 106/monitor 105. A color value [R₀, G₀ B₀] is considered reachable by projector/monitor i if there exists an input color vector [Rᵢ Gᵢ Bᵢ] that yields the observed color vector [R₀ G₀ B₀] through the observed projector/monitor color response. This color response is a function, T(I), that maps the input digital tri-stimulus color values Red, Blue, Green (R, G, B) to a wavelength distribution on a display surface:

PR(RᵢGᵢBᵢ)=Π₀.

The observed projector/monitor color response is a function that describes the digital tri-stimulus values input to a projector 106/monitor 105 and their corresponding digital tri-stimulus values observed with a digital camera. The observed projector/monitor color response for display i may be expressed as:

POᵢ(R,G,B)=[RGB]₀

A color value is reachable if the display is able to generate that color value. That is,

[R₀,G₀B₀]=POᵢ([RᵢGᵢBᵢ]) for any choice of [RᵢGᵢBᵢ].

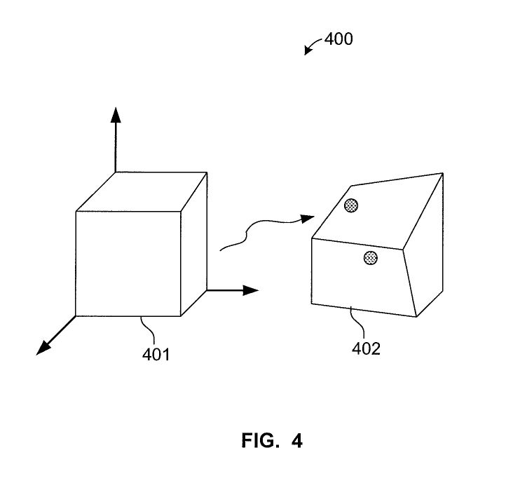

If the projector/monitor exhibits a linear response, then this distortion, which represents the difference between the device-specific color response function and the target color values, can be modeled as a linear distortion within the tri-stimulus space with no loss of accuracy, as illustrated in FIG. 4. As a result, once the projector/monitor output has been linearized, only the vertices of the gamut in the tri-stimulus color space need to be observed with a camera.

In the computation phase 311, a common reachable gamut in the observed color space is derived. In one embodiment, each of the observed gamuts, gᵢ is intersected to derive a common gamut G in the observed color space. The intersection of the gamut volumes can be accomplished via constructive solid geometry or other similar approaches. The result is a three-dimensional polyhedron that describes the target device-specific color space C for each projector 106/monitor 105.

To measure the response of a single linearized projector 106/monitor 105, then, each of the colors of the gamut vertices (black, red, green, blue, cyan, magenta, white) is displayed, at step 308, and the response is observed using camera 104, at step 309. The color response is then modeled, in step 310, and may be represented by a polyhedron in the color space that describes the reachable color space for that projector/monitor, for example, polyhedron 402 in FIG. 4.

At step 312, the target device specific color space is determined for each projector/monitor. In an exemplary embodiment, each projector/monitor is mapped, from its observed gamut gᵢ to this common observed volume by determining the 4×4 projective transform T that maps gᵢ to C via least-squares:

C=cT_{G}_{^{g}}ᵢ

The above transform correlates the observed device-specific values to the target color space, so the (unknown) function that describes this mapping from the set of observations needs to be determined.

The linear distortion of each projector/monitor is modeled as a projective transform T, encoded as a 4×4 projective matrix that maps input gamut colors (gᵢ) to observed colors (oᵢ):

oᵢT_{gi}

A similar observed gamut for each projector/monitor is next measured at step 313. This results in a family or set of gamuts in a common observed color space.

At step 315, a set of transforms, Pₖ, is derived, each of which takes a respective gamut model Fₖ(I) to F_{T}(I). Pₖ can be a single projective (linear) transform, a lookup table that directly maps Ito T(I) for projector k, or a set of subspace transforms that map part of the gamut space.

A common color space mapping transform is therefore derived that minimizes the L2 norm of the points in the observed gamut space and the common color space. This common color space mapping may be computed via gamut intersection, at step 316. Either all of the gamuts are intersected to compute a reachable volume, or a single color value is selected for a given input. An example of this common color space mapping transform is shown below.

Transform 1

$$\begin{matrix}arg min \\ {}_{c}^{}{T}{}_{G}^{}\end{matrix} {\sum }_{1}^{k} {‖ {C}_{i} - {cT}_{G} {g}_{i} ‖}_{2}$$

The resulting transform (Transform 1) maps the observed gamut to a common color space. When this is composed with the initial transform T that takes each projector/monitor into the observed space (where intersections of the polyhedrons are computed), then a full mapping is obtained that takes a projector/monitor input color value to a common color response space for all projectors/monitors.

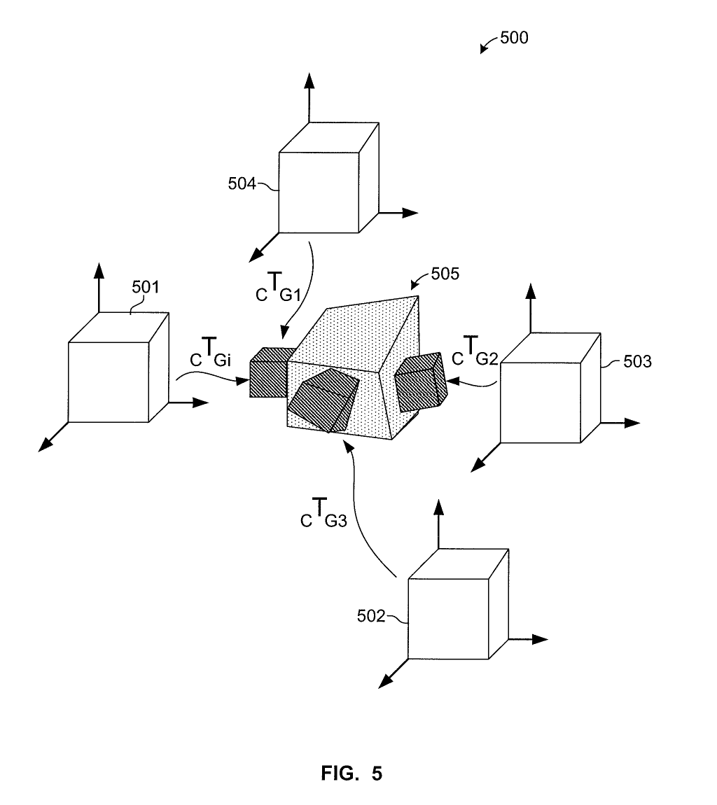

FIG. 5 shows an exemplary result of mapping the gamuts 501, 502, 503, 504 for multiple projectors/monitors into a common observed space 505. The intersection of these gamuts describes the common reachable color space 505.

The target gamut can be specified as other than the largest common gamut. For example, a target gamut may have the additional constraint that the colors red, green, blue remain within a predetermined distance from the primary color axes. In addition to a single linear transform, there are a number of methods of representing the transform T that maps each projector color space to the target gamut including:

(1) a lookup table where the direct difference between an input value and the corresponding target value is written directly into a lookup table.

(2) the method described in (1) above, where a function for interpolating between the vertices takes into account a known nonlinearity. In this case, the linearization step is skipped and, instead, interpolation is performed using the known projector nonlinear response to weight the interpolation operation.

(3) the case when a single transform is used. The lookup table approach can represent any transform (including nonlinearities) and therefore the linearization process indicated in step 306 (FIGS. 3A and 3B) may be omitted when lookup tables are employed. The lookup tables can be generated directly from the process shown in FIGS. 3 and 4. That is, one can fit one or more parametric functions to the observation/target pairs and then use those functions to generate a lookup table by querying the function(s). This may be done for runtime correction, speed, or reasons other than representing the parametric function explicitly. (4) the case (which is essentially an extension of case (3), above) when a set of parametric transforms are fit to the data over local areas in the gamut (for example all colors in some region of the input space are fit to a particular function and that function is used). If the entire space can be modeled by a particular transform, then a single transform is used. If, however, this would result in error (due to the transform being an approximation of the underlying complexity), then the error can be mitigated by using a set of local parametric transforms that better fit the data locally.

Finally, the selected method of representing the transform may be included in the ‘linearization’ process where the transforms/lookup tables, etc., are used in the linear space and then are delinearized at the end of the process.

The above techniques may be extended to other situations including the alternative embodiments described below.

1. When each ‘subspace’ of the full gamut is a single color value, a function is used to map a single color value from each projector to the target color rather than a family of colors over a region of the color space. This is referred to as a ‘direct’ mapping, rather than a ‘functional’ mapping, where a function or transform is used for determining the mapping. The transform may comprise a single matrix, multiple matrices, or a lookup table.

Because the direct mapping can be stored as a lookup table, it may involve only a single color transform. This direct mapping bypasses the ‘common gamut’ calculation (step 316) entirely and, instead, maps a color to a ‘common’ color that is reachable by all projectors.

2. When not all color values have a direct mapping, colors in the space that do not correspond to a direct value may be derived (e.g., via interpolation).

3. In another alternative embodiment, camera 104 may be used to take measurements of the color values in two or more different projectors/monitors, observe the difference, and then drive the projectors/monitors such that the observed difference is minimized. When this difference is minimized, a direct mapping value for that color is discovered. This can be accomplished via a process in which the projectors iteratively display colors and their differences are measured in the camera until a minimum is reached. This minimization process may utilize standard minimization/search methods. For example, using a Downhill Simplex or Levenburg-Marquadt method, the difference between two color values can be minimized through iterative functional minimization.

Alternatively, the difference in observed color values can be minimized via a ‘line search’. Consider two output values O₁ and O₂ from projectors 1 and 2 respectively. These two points define a line in the output color space of the camera. Therefore a new target color value T_{C} in the camera can be determined simply by computing the midpoint of this line. Given this target color value, and the known projector response functions, new projector input values O′₁ and O′₂ are derived such that the expected observed color will be seen in both projectors. Errors in the camera observation process, the projector response functions, and other sources may mean that the observed values for those input values may not be close enough to T_{C}. In this case, the process is repeated until no significant further improvement is made.

4. When the color transforms are computed ‘opportunistically’ (in both the functional mapping and direct mapping cases), the display is observed using normally-displayed images (rather than displaying a predetermined image or set of images) via sensor 104 to capture color samples from the constituent projectors 106/monitors 105, where the colors are known to be in correspondence by observing the data that was sent to the projectors/monitors. For example, if a particular pixel (or pixel group) in one projector is known to be red [255,0,0] and another pixel in a second projector is known to be red [255,0,0], the difference between the observed color correspondence is measured and a correction is derived.

Color correction can occur in a single step (i.e., by selecting a color that is directly between the two observed values) and may comprise updating the direct function, or the observed samples can be used to derive a new functional mapping for that part of the color subspace.

In another embodiment, a search is used to determine the color transform. In this embodiment, each projector is interactively and iteratively driven until the correspondences are observed to be the same.

A color transform may be derived by reading back an image from a framebuffer (from the end of the buffer) in storage area 103 and search for positions in the image that (1) have the same color and (2) will be seen in different projectors/monitors. Alternatively, corresponding colors may be generated and embedded in an image before it is displayed.

In an exemplary embodiment, the entire process described above with respect to FIG. 3A can be performed in real-time to support online color correction of multiple devices. In this embodiment, measurement phase 301 opportunistically extracts color values that are being projected as part of the normal operation of the projectors/monitors in step 302. When the same color happens to be shown across multiple projectors/monitors at a given moment, a camera image is captured and the results of that measurement are stored.

### Runtime Correction Phase

In the runtime correction phase 321, the derived color correction functions are applied to projector/monitor input color values at display runtime. This is accomplished by mapping each input color vector to a corrected input color that will result in the correct output response of the projector 106/monitor 105, at step 322. That is, given the mapping transforms produced by the measurement and computation phases, for any given input [R G B] value, a corresponding triple [\hat{R} Ĝ \hat{B}] is derived that, when input into a specific projector/monitor, will result in an observed color value that is similar in appearance to another projector/monitor in the system. The application of these transforms can take place in software (e.g., in a GPU shader program) or in hardware.

For each given input color value, the color value is first mapped from the input space to observed (camera) space, at step 323. This is accomplished by multiplying the input color vector through a transform _{O}T_{I}, or any other transform that was computed during the computation phase. For example, this mapping can be accomplished via a lookup table or an appropriate transform among a set of transforms that span subspaces of the color space. A subspace is a portion of the color space that defines the input, output, or target colors. In this case, the term refers to a continuous set of color values in the color space that is less than or equal to the total color space. The term “continuous” refers to a single volume whose constituent colors all are reachable from one another via some distance/neighborhood function.

The _{O}T_{I} transform is the same for all projectors and maps input color values to common camera space (defined by the common gamut derived in the computation phase). This results in a distorted polyhedron (e.g., polyhedron 402 in FIG. 4) that either encompasses the entire transformed color space, or represents the transformed verticies of the input subspace (in the case where multiple transformations are being used to model the space) in the camera observed space that encodes the color value that the measurement camera would observe, given that input color value. This color value is then transformed into the device-specific color space via the recovered transformation _{C}T_{G}, which is specific to each display device. The result is a color value that [when displayed by a projector] would be observed in the common space by the camera (or observer) for that desired input value.

At step 324, each color value is transformed by the inverse of the color correction function (i.e., the inverse of the _{O}T_{I} transform) that maps projector- (or monitor-) to-camera response, to derive an appropriate color value in the projector/monitor space. The application of the inverse of the color response function effectively delinearizes the process and results in color values that can be provided directly to the (potentially) nonlinear display device. The resulting color value when input to the projector/monitor results in the expected output color in the camera, and is very similar in appearance in the camera to the output color of other projectors that undergo the same process. Finally, the output of this process is optionally mapped via a nonlinear function ‘f’ to delinearize the process, at step 325, thus generating a color-corrected RGB vector 326. Delinearization is not performed if a given projector/monitor is known to be linear.

The set of parametric transforms can be pre-multiplied into a single transformation pipeline (shown below in an example) that can be applied quickly at runtime:

### Exemplary Transformation Pipeline

$$[ \begin{matrix}\hat{R} \\ \hat{G} \\ \hat{B}\end{matrix} ] = \int ( [ {( {}_{o}^{}{T}{}_{l}^{} )}^{- 1} {}_{c}^{}{T}{}_{G}^{} \cdot {}_{o}^{}{T}{}_{l}^{} ] [ \begin{matrix}R \\ G \\ B\end{matrix} ] )$$

At step 330, the resulting RGB vector is output to the projector/monitor to yield a color value that is aligned with the same color as displayed via the other displays. This process may be applied to every pixel input to a projector/monitor to yield coherent and color-aligned images.

Having described the invention in detail and by reference to specific embodiments thereof, it will be apparent that modifications and variations are possible without departing from the scope of the invention defined in the appended claims. More specifically, it is contemplated that the present system is not limited to the specifically-disclosed aspects thereof.

What is claimed is:

1. A method of generating a display from a plurality of color image display sources, the method comprising:
determining a non-linear color response for each of the display sources;
linearizing each of the display sources using the inverse of a respective said non-linear color response;
deriving a common reachable gamut in an observed color space for each of the display sources;
determining, for each of the display sources, a transform that maps an observed gamut to a target device-specific color space; and
applying the respective said transform to color values input to each of the display sources.

2. The method of claim 1, wherein said display sources each comprise a video monitor.

3. The method of claim 1, wherein said display sources each comprise a visual image projector.
